(19) United States
(12) Patent Application Publication
(10) Pub. No.: US 2018/0271324 A1
(43) Pub. Date: Sep. 27, 2018

(54) BARBEQUE GRILL GAS FLOW-TIMER ASSEMBLY

(71) Applicant: AEI, Corporation, Irvine, CA (US)

(72) Inventor: Philip H. Arnold, Irvine, CA (US)

(21) Appl. No.: 15/470,677

(22) Filed: Mar. 27, 2017

(51) Int. Cl. A47J 37/07; F16K 31/48; G04F 3/02; F23N 5/20

(52) U.S. Cl. CPC A47J 37/0713; F16K 31/48; F23N 5/203; F16K 31/485; G04F 3/027

(57) ABSTRACT

A gas flow-timer assembly for use with a barbecue gas grill having at least one burner valve with a first burner controller to heat at least one corresponding grill burner. The first burner controller is disposable onto a first burner valve. The gas flow-timer assembly also includes a gas flow-timer manifold disposable onto a gas input line from the gas source. The gas flow-timer manifold is also disposable onto a gas output line connected to the first burner valve. The gas flow-timer manifold further includes a gas flow-timer to regulate the delivery of gas from the gas flow-timer manifold, through the gas output line, to the first burner valve for a selected duration of time.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates to gas flow-timer systems for barbeque grills. More particularly, the present disclosure relates to a barbeque grill gas flow-timer assembly.

### 2. Discussion of Related Art

The grounds enclosing multi-family apartment or condominium complexes and the picnic areas found in parks are often equipped with barbecue grills available for public use by residents or visitors. Typically, a barbecue gas grill includes a burner area where food is cooked, a cover over the burner area, at least one burner valve that opens and closes the delivery of a gas (usually natural gas) to the burner area, an igniter to ignite the gas under the burner area, and a gas line that delivers gas from the gas source to the burner valve.

Due to the frequency of their use, such “shared” barbecue grills may have parts that are missing or broken due to misuse, theft, etc. Because they do not own these “shared” barbecue grills, such users may be less inclined to pay adequate attention after finishing their grilling to shut off the burner or gas valves. This leads to the costly waste of natural gas or depletion or emptying of the gas source, thereby preventing further use and enjoyment of the grill by others. Also, these users may be less inclined to take proper care of the barbecue grill, either because they are not familiar with its correct use or because they do not assume responsibility for the repair of the barbecue grill, should something happen to it. The control knobs for the burner valves are especially susceptible to loss or breakage due to their high visibility on the grill panel, the ease with which they can be loosened or removed, and their frequent usage. Similarly, residential homeowners oftentimes forget to turn “off” the barbeque grill after use posing a substantial burn or fire danger to themselves and others.

Therefore, a need exists for a barbecue grill that can automatically shut off the delivery of gas to the burner valve(s) after a specified duration of time, that reduces the likelihood that control knobs will be removed from the grill panel, and that offers clear and highly visible instructions on the barbecue grill as to its proper use and operation.

### BRIEF SUMMARY

According to an aspect of the present disclosure, a barbeque grill gas flow-timer assembly for use with a barbecue gas grill having at least one burner valve and an igniter to heat the grill burner by igniting gas delivered to the burner valve includes a first burner controller disposable onto the first burner valve, a gas flow-timer manifold disposable onto both a gas input line from a gas supply and a gas output line to the first burner valve, and a gas flow-timer on the gas flow-timer manifold to regulate the delivery of gas through the gas flow-timer manifold to the first burner valve for a selected duration of time.

In another embodiment, the gas flow-timer assembly further includes a second burner controller disposable onto a second burner valve of the barbecue grill, the gas output line being further connected to the second burner valve with the gas flow-timer regulating the delivery of gas to the second burner valve for a selected duration of time. In other embodiments of the barbecue grill, it is contemplated that third, fourth, fifth etc. burner controllers are utilized with third, fourth, fifth burner valves connected to a corresponding number of grill burners.

According to another aspect of the present disclosure, the gas flow-timer includes a gas flow-timer controller.

In another embodiment of the present disclosure, the first burner controller includes a first set screw insertable through a first set screw opening to lock the first burner control to the first burner valve. In yet a further embodiment, the second burner controller is also secured to to the second burner valve by the insertion of another first set screw through its first set screw opening. According to another aspect of the present disclosure, the gas flow-timer controller may include a second set screw insertable through a second set screw opening to lock the gas flow-timer controller to the gas-flow timer.

In another embodiment, the assembly may further include a grill panel proximate the gas flow-timer. The grill panel may be comprised of a material on which is laser-etched an instructional statement about how to use the gas flow-timer grill and/or safely operate the same.

According to another embodiment of the present disclosure, the gas flow-timer assembly further includes a first burner controller disposable onto the first burner valve. The first burner controller has a first set screw disposed through a first set screw opening to lock the first burner controller to the first burner valve. In this embodiment, the assembly also includes a second burner controller that is secured to the second burner valve with the first set screw disposed through the first set screw opening. The assembly further includes a gas flow-timer manifold disposable onto both a gas input line from a gas supply and a gas output line to the first burner valve and the second burner valve. In this embodiment, attached to the gas flow-timer manifold is a gas flow-timer having a gas flow-timer controller to regulate the delivery of gas through the gas flow-timer manifold, the first burner valve, and the second burner valve for a selected duration of time. The gas flow-timer controller further has a second set screw disposed through a second set screw opening to lock the gas flow-timer controller to the gas flow timer. Finally, this embodiment also includes a grill panel proximate the gas flow timer. The grill panel has a laser-etched instructional description on how to use the gas flow-timer grill.

### BRIEF DESCRIPTION OF THE DRAWINGS

These and other features and advantages of the various barbeque grill gas flow-timer assembly embodiments disclosed herein will be better understood with respect to the following description and drawings, in which like numbers refer to like parts throughout, and in which:

FIG. 1 is a perspective view illustrating the barbeque grill gas flow-timer assembly installed proximate the front panel of a barbeque grill, highlighting the gas flow-timer controller next to a burner controller;

FIG. 2 is a perspective view of a barbeque grill gas flow-timer assembly in accordance with an embodiment of the present disclosure, with the gas flow-timer on the gas flow-timer controller installed on the gas flow-timer manifold, with a gas input line and a gas output line connected to the gas flow-timer manifold;

FIG. 3 is a perspective view of the gas flow-timer controller being attached and locked to the gas flow-timer by a second set screw, and the first burner controller being attached and locked to a first burner valve by a first set screw, in accordance with an embodiment of the present disclosure;

FIG. 4 is an exploded view of the first set screw locking the first burner controller to the first burner valve;

FIG. 5 is perspective view of the front panel of the barbeque grill proximate the gas flow-timer, with a laser-etched instructional description on the grill panel describing how to use the barbeque grill gas flow-timer, in accordance with an embodiment of the present disclosure; and

FIG. 6 is an exploded view of the front panel depicting the laser-etching of the instructional statement of operation on how to use the barbeque grill gas flow-timer.

### DETAILED DESCRIPTION

Hereinafter, embodiments of a barbeque grill gas flow-timer assembly are described with reference to the accompanying drawings.

This description may use the phrases “in an embodiment,” “in embodiments,” “in some embodiments,” or “in other embodiments,” which may each refer to one or more of the same or different embodiments in accordance with the present disclosure.

It is to be understood that the terminology used herein is for the purpose of describing particular embodiments only, and is not intended to be limiting. As it is used in this description, “gas” or “fuel” may include propane, butane, other liquid petroleum gases, or natural gas. As used herein, the term “timer” generally refers to a mechanical, electronic, or digital timer that counts down from a specified duration of time measured in minutes to hours, depending on the time interval reflected on the timer.

As it is used in this description, “set screw” refers to a screw, bolt, or other fastener generally used to secure an object within or against another object by compression forces.

As it is used in this description, “laser-etched” refers to the use of a laser to etch, engrave, or mark an object made of metal, plastic, stone, glass, or natural materials such as wood.

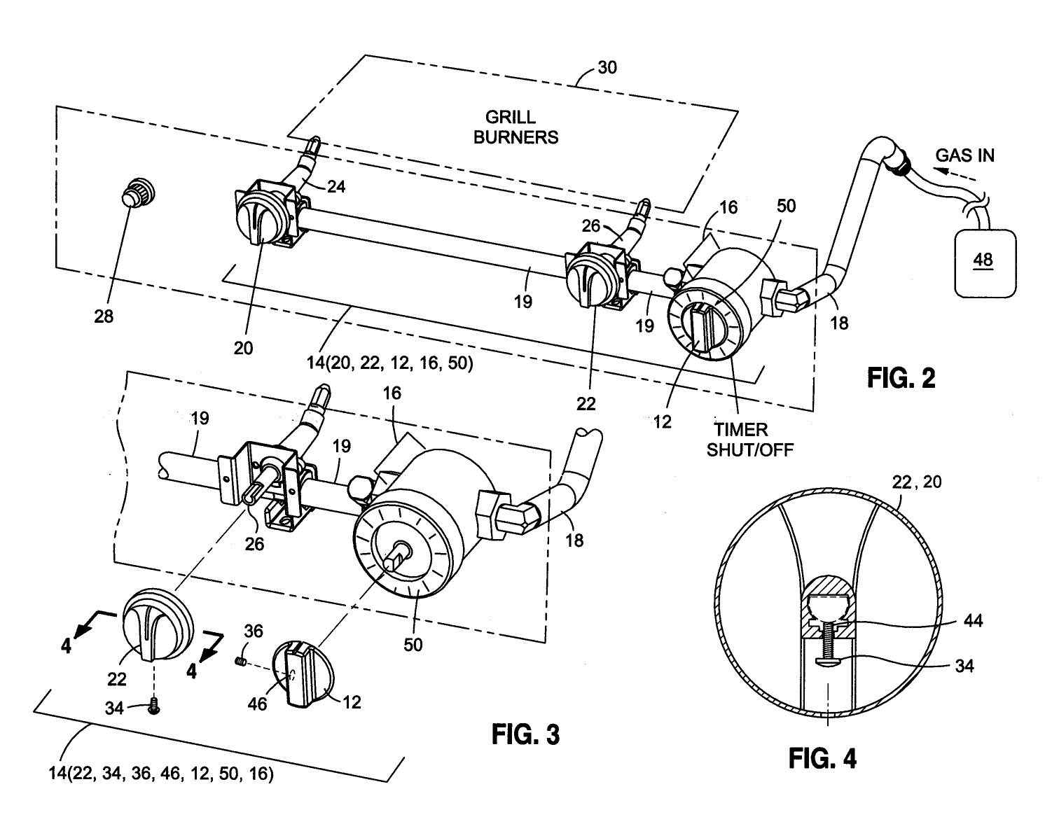

The presently disclosed barbeque grill gas flow-timer assembly is referred to generally in FIGS. 2-3 by the reference numeral 14. In the embodiment illustrated in FIGS. 2-3, the barbeque grill gas flow-timer assembly 14 includes a first burner controller 22, a second burner controller 20, a gas flow-timer 50, a gas flow-timer controller 12, and a gas flow-timer manifold 16. The first burner controller 22 is disposable onto the first burner valve 26 of the barbeque grill 10. The second burner controller 20 is disposable onto the second burner valve 24 of the barbeque grill 10. As shown in FIG. 2, the gas flow-timer 50 is connected to a gas flow-timer manifold 16 which is configured for attachment onto the gas input line 18, which is in turn connected to the gas supply or gas source 48 containing an appropriate fuel (e.g., propane gas) or connected directly to a gas source such as a natural gas supply line (not shown). Further shown in the embodiment illustrated in FIG. 2 is the outlet of the gas flow-timer manifold 50 which is configured for attachment onto a gas output line or manifold 19, which is connected to the first burner valve 26 and the second burner valve 24. Although only shown with two burner controllers 20 and 22 which are connected to separate grill burners 30, those skilled in the art will recognize that a single burner controller or additional burner controllers and grill burners are contemplated herein and within the scope of the present invention.

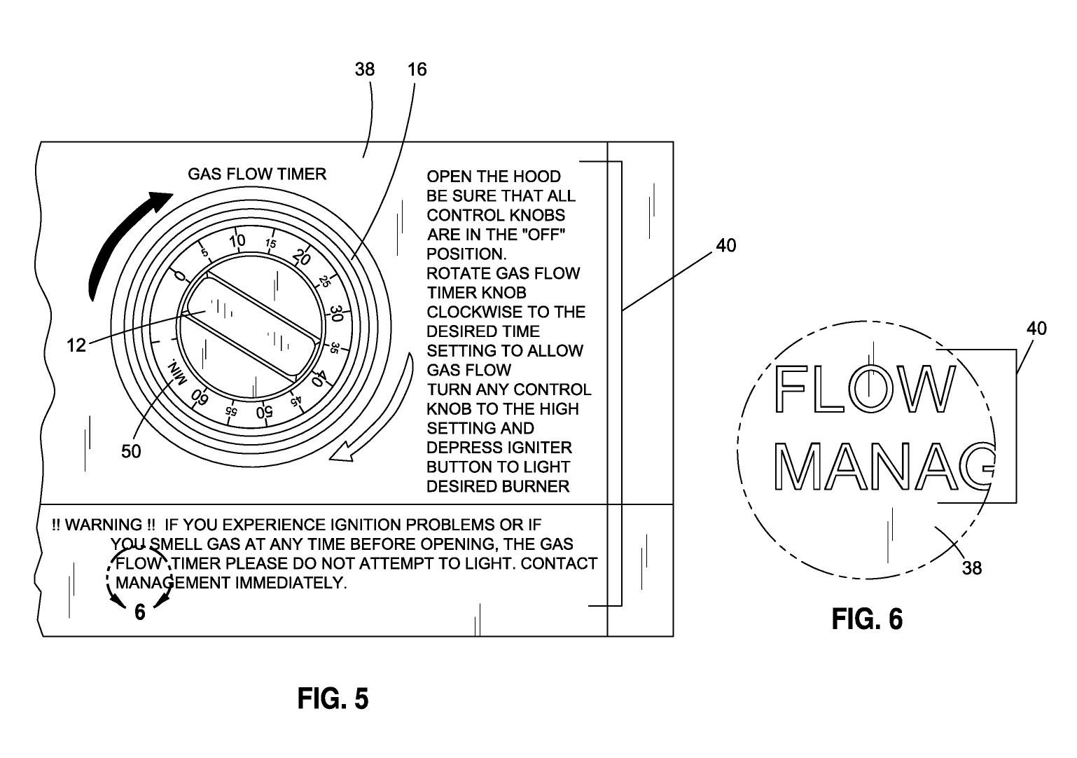

The barbeque grill gas flow-timer assembly 14 is designed to allow the user to activate the delivery of fuel from the gas supply or gas source 48 through the gas flow-timer manifold 16, the first burner valve 26, and the second burner valve 24 for a selected duration of time. In the embodiment depicted in FIG. 5, the gas flow-timer 50 is marked and may be set at five-minute increments up to one-hour. Those skilled in the art will recognize that the gas flow-timer 50 can be made to measure different increments and durations of time. In the preferred embodiment, the gas flow-timer assembly is manufactured by Universal Gas Valve Manufacturing and is expressly incorporated herein by reference. However, those having skill in the art recognize that numerous mechanical or electrical timer gas shut off valves are contemplated herein.

The installation and use of the gas flow-timer assembly 14 enables the gas flow-timer to regulate how long gas is allowed to travel from the gas flow-timer manifold 16, through the gas output line 19, and to the first burner valve 26 and the second burner valve 24. Once the specified duration of time set on the gas flow-timer 50 has elapsed, gas is no longer able to pass from the gas flow-timer manifold 16 to the first burner valve 26 and the second burner valve 24. This automatic gas “shut off” after the time set on the gas flow-timer 50 has elapsed prevents the inadvertent emptying of the gas source or continued burning of gas when the barbecue grill 10 is not being used.

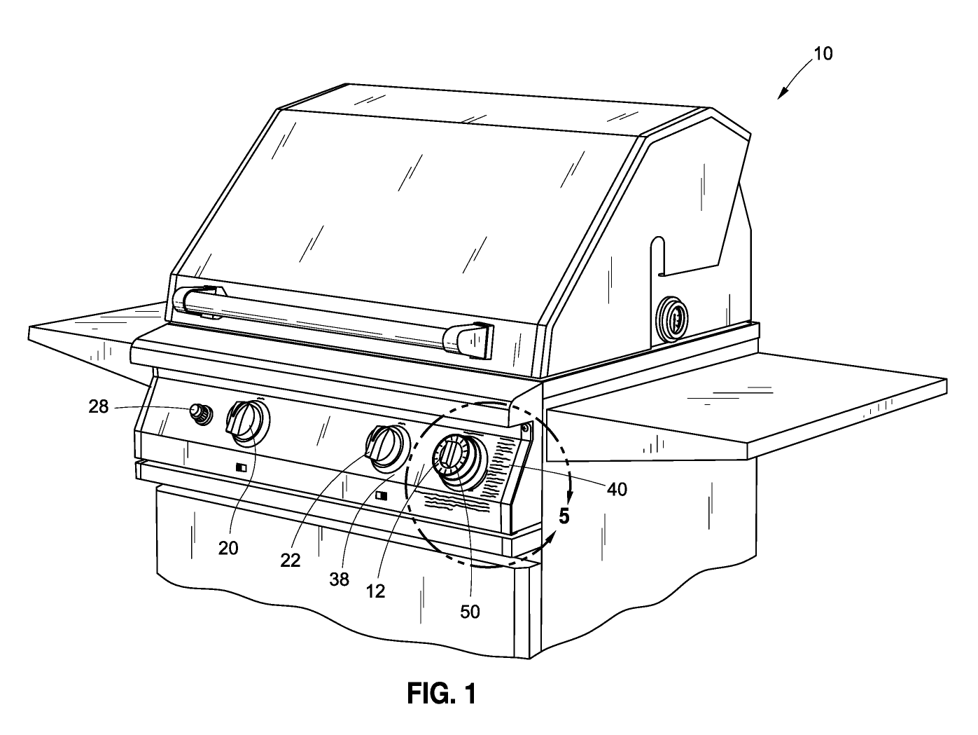

As indicated in the embodiment of the barbeque grill gas flow-timer assembly 14 illustrated in FIG. 5, a laser-etched instructional description 40 on how to use and safely operate the gas flow-timer grill is imprinted onto the grill panel 38. Those skilled in the art will recognize that the grill panel 38 may be made from a variety of materials capable of being laser-etched, including, but not limited to, metal, stone, or natural material finishes that can also withstand being in close proximity to higher temperatures. In the preferred embodiment a stainless steel metal is utilized. The laser-etched instruction 40 in FIG. 5 states that the clockwise rotation of the gas flow-timer controller (knob) 12 to a selected duration of time enables the flow of gas from a natural gas supply or the gas source 48. The gas is then enabled to pass from the gas input line 18 to the gas flow-timer manifold 16, and into the gas output line 19. The turning of either the first burner controller 22 at the first burner valve 26 and/or the second burner controller 20 at the second burner valve 24 while concurrently depressing the igniter 28, as shown in FIG. 2 and described in FIG. 5, enables the lighting of the desired grill burner 30. FIG. 6 is a magnification of the laser-etched instruction 40 on the grill panel 38 of the barbecue grill 10. In the embodiment illustrated in FIG. 1, the laser-etched instructions 40 are proximate the gas flow-timer 50.

The inclusion of instructions on the grill panel 38 will encourage and assist users to operate the barbeque grill gas flow-timer assembly 14 properly, thereby reducing the likelihood of misuse and damage to the barbecue grill 10. Because the instructions are laser-etched 40 in a highly visible, easily accessible location on the barbecue grill 10, users will be able to readily find the instructions 40 and shall be less likely to misplace them.

In some embodiments, as shown for example in FIGS. 2 and 3, the first burner controller 22 and second burner controller 20 further include a first set screw 34 insertable through a first set screw opening 44 to lock the first burner controller 22 to the first burner valve 26 and the second burner controller 20 to the second burner valve 24. FIG. 4 shows a cross-sectional cut-out view of the the first burner controller 22 and the second burner controller 20 being engaged by the first set screw 34 through the first set screw opening 44. The installation and use of the first set screw 34 allows the secure fitting of the first burner controller 22 and the second burner controller 20 to respectively the first burner valve 26 and the second burner valve 24 on the barbeque grill 10, so that these controllers 20, 22 are not lost or taken off of the barbeque grill 10. In view of the high traffic use of the barbeque grill 10 in the common areas of multi-family residences, the installation and use of the first set screws 34 will mitigate against the need for the frequent replacement of the first burner controller 22 and the second burner controller 20.

In another embodiment of the barbeque gas flow-timer assembly 14, as again illustrated in FIG. 3, the gas flow-timer controller 12 may include a second set screw 36 insertable through a second set screw opening 46 to secure the gas flow-timer controller 12 to the gas flow-timer 50. As with the first burner controller 22 and the second burner controller 20, the gas flow-timer controller 12 can be secured to the barbeque grill 10 so as to reduce the likelihood of its loss or theft in high-traffic areas such as those found in the common areas of multi-family residences or parks where the barbeque gas flow-timer assembly 14 may be located and used.

In another embodiment, as shown for example in FIGS. 1 and 3, the barbeque grill gas flow-timer assembly 14 may include the first burner controller 22 with a first set screw 32 disposed therethrough to lock the first burner controller 22 to the first burner valve 26, a second burner controller 20 using the first set screw 32 to lock the second burner controller 20 to the second burner valve 24, a gas flow-timer 50 attached to the gas flow-timer manifold 16 with a gas flow-timer controller 12 regulating the input of fuel gas for a selected duration of time with the gas flow-timer controller 12 locked to the gas flow-timer 50 by a second set screw 36, and a grill panel 38 proximate the gas flow-timer 50 with laser-etched instructions 40 on how to use the barbeque grill gas flow-timer 50.

Although embodiments have been described in detail with reference to the accompanying drawings for the purpose of illustration and description, it is to be understood that the disclosed systems and processes are not to be construed as limited thereby. It will be apparent to those of ordinary skill in the art that various modifications to the foregoing embodiments may be made without departing from the scope of the disclosure.

What is claimed is:

1. A gas flow-timer assembly for use with a barbecue gas grill having at least one burner valve to heat at least one grill burner by igniting gas delivered through a gas line connected to a gas source, the assembly comprising:
a first burner controller disposable onto a first burner valve;
a gas flow-timer manifold disposable onto both a gas input line from the gas source and a gas output line to the first burner valve; and
a gas flow-timer on the gas flow-timer manifold to regulate the delivery of gas from the gas flow-timer manifold through the gas output line to the first burner valve for a selected duration of time.

2. The assembly as claimed in claim 1, wherein the gas flow-timer assembly further includes a second burner controller disposable onto a second burner valve of the barbecue grill, the gas output line being further connected to the second burner valve for the gas flow-timer to regulate the delivery of gas to the second burner valve for a selected duration of time.

3. The assembly as claimed in claim 1, wherein the gas flow-timer further includes a gas flow-timer controller.

4. The assembly as claimed in claim 1 wherein the first burner controller further includes a first set screw insertable through a first set screw opening to lock the first burner controller to the first burner valve.

5. The assembly as claimed in claim 1 further includes a grill panel proximate the gas flow timer, the grill panel being comprised of a material on which is laser-etched an instructional description on how to use the gas flow-timer grill.

6. The assembly as claimed in claim 2, wherein the second burner controller further includes the first set screw insertable through the first set screw opening to lock the second burner controller to the second burner valve.

7. The assembly as claimed in claim 3, wherein the gas flow-timer controller further includes a second set screw insertable through a second set screw opening to lock the gas flow-timer controller to the gas flow timer.

8. A gas flow-timer assembly for use with a barbecue gas grill having a first burner valve and a second burner valve to heat the grill burner by igniting gas delivered through a gas line connected to a gas source, the assembly comprising:
a first burner controller disposable onto the first burner valve, the first burner controller having a first set screw disposed through a first set screw opening to lock the first burner controller to the first burner valve;
a second burner controller disposable onto the second burner valve, the second burner controller further includes another first set screw disposed through the first set screw opening to lock the second burner controller to the second burner valve;
a gas flow-timer manifold disposable onto both a gas input line from the gas source and a gas output line to the first burner valve and the second burner valve;
a gas flow-timer attached to the gas flow-timer manifold, the glass flow-timer having a gas flow-timer controller to regulate the delivery of gas through the gas flow-timer manifold, the first burner valve, and the second burner valve for a selected duration of time, the gas flow-timer controller further having a second set screw disposed through a second set screw opening to lock the gas flow-timer controller to the gas flow timer; and
a grill panel proximate the gas flow timer having a laser-etched instructional description on how to use the gas flow-timer grill.
